(19) United States
(12) Patent Application Publication
(10) Pub. No.: US 2026/0318816 A1
(43) Pub. Date: Oct. 15, 2026

(54) AN APPARATUS FOR DETERMINING INFORMATION RELATING TO ELEMENTS OF A BODY FLUID AND A METHOD OF DETERMINING THAT INFORMATION

(71) Applicant: Radiometer Medical ApS, Brønshøj (DK)

(72) Inventors: Peter Emil LARSEN, Brønshøj (DK); Andreas Erik Gejl MADSEN, Brønshøj (DK)

(21) Appl. No.: 19/100,961

(22) PCT Filed: Sep. 29, 2023
(86) PCT No.: PCT/EP2023/077036

§ 371 Date: Feb. 4, 2025

(30) Foreign Application Priority Data
Sep. 30, 2022 (EP) 22199151.6

(51) Int. Cl. G01N 15/1434; G03H 1/00

(52) U.S. Cl. CPC G01N 15/1434; G03H 1/0005; G01N 2015/144; G03H 2001/0033

(57) ABSTRACT

An apparatus and a method determine information relating to particles, such as cells, in a liquid where images are generated with different focus lengths and at different points in time. From the images, the particle movement over time is determined for a plurality of individual cells, bacteria, platelets, or the like; and therefrom, their densities and/or types.

The present method relates to an apparatus for determining information relating to elements of a body fluid and a method of determining that information and in particular for determining information relating to more or less solid elements of a body fluid, such as cells, bacteria and the like.

Historically, cell identification or classification has been performed visually by a human operator or expert. Other technologies, such as DNA staining and the like, have also been used.

Image based cell identification is a widely known technique and the densities of individual cell types are known.

Relevant technology may be seen in:
BERNHARDT I ET AL: “Application of digital holographic microscopy to investigate the sedimentation of intact red blood cells and their interaction with artificial surfaces”, BIOELECTROCHEMISTRY, ELESEVIER, AMSTERDAM, NL, vol. 73, no. 2, 1 Aug. 2008 (Aug. 1, 2008), pages 92-96, XP023784160, ISSN: 1567-5394, DOI: 10.1016/J. BIOELECHEM.2007.12.001
YU XIAO ET AL: “Review of digital holographic microscopy for three-dimensional profiling and tracking”, OPTICAL ENGINEERING, SOC. OF PHOTO-OPTICAL INSTRUMENTATION ENGINEERS, BELLINGHAM, vol. 53, no. 11, 1 Nov. 2014 (Nov. 1, 2014), page 112306, XP060048121, ISSN: 0091-3286, DOI: 10.1117/1.0E.53.11.112306
SANG-HYUK LEE ET AL: “Characterizing and tracking single colloidal particles with video holographic microscopy”, ARXIV. ORG, CORNELL UNIVERSITY LIBRARY, 201 OLIN LIBRARY CORNELL UNIVERSITY ITHACA, NY 14853, 11 Dec. 2007(Dec. 11, 2007), XP080 345670.

In a first aspect, the present invention relates to an apparatus according to claim 1

In this context, the elements of the apparatus may be attached to each other or may simply be positioned suitably in relation to each other.

The body fluid may, e.g. be blood, saliva, milk and/or urine, and the elements therein may be cells, such as blood cells, such as white blood cells WBCs, red blood cell RBCs and pathological cells such as circulating tumor cells CTCs, nucleated red blood cells nRBCs and the like, epithelial cells, platelets, bacteria, parasites, protein, or other constituents of body fluids.

A sample container is provided for and configured to comprising a sample of the body fluid comprising the elements. The sample container may be of any desired type. Often, the sample container comprises or is made of a translucent material allowing light or radiation to pass through the sample and the sample container in order for the imaging element to provide the imaging information. The sample container, when comprising the sample, may allow the sample to have a predetermined or a minimum height along a vertical direction so that cells present in the sample are allowed to move along a vertical direction, such as for up to a predetermined distance, without impinging on the sample container.

The sample may be of untreated and unfiltered body fluid, or the sample may comprise only part of the body fluid, such as if the body fluid has been filtered or otherwise prepared by e.g., removing elements thereof, such as red blood cells. The sample may be prepared by adding to the body fluid one or more agents configured to alter one or more parameters or constituents of the body fluid. For example, red blood cells may be filtered or lysed using a lysing agent.

A sample may be a collected sample of body fluid comprising elements with associated properties, wherein the associated properties substantially correspond to associated properties of the elements in the body fluid before being collected. The sample may be a body fluid sample in which particular types of cells are removed or lysed. A sample may be a diluted body fluid sample. An imaging element is provided which is configured to generate a sequence, over time, of imaging information. Thus, the imaging element may be suitably positioned at or around the sample container. The sample container and imaging element may be adapted to each other in order to facilitate outputting the desired imaging information.

The imaging element is provided to generate the sequence of imaging information. Thus, a plurality of imaging information is provided and each imaging information is generated at a separate point in time. The imaging information may be generated at equidistant points in time, such as each second, every 2 seconds, every 4 seconds, every 5 seconds, every 10 seconds, every 15 seconds, or every 20 seconds.

Each imaging information comprises information representing an image of the sample in the sample container and at, at least two different focus lengths/depths. Thus, each imaging information may itself comprise a number of images each having a particular or distinct focus length/depth. Then, the imaging information will be provided during a period of time, where the periods of time of different imaging information then preferably do not overlap so that the plurality of imaging information are derived over time. Alternatively, it may be desired that all represented images, one of each imaging information, representing a particular focus length/depth are provided at different points in time, so that the represented images at other depths may be provided at different points in time.

The imaging information comprises information representing an image of the sample at, at least two different focus lengths/depths. Such information may be provided by actual images derived using optics providing the desired focus depth/length. In another situation, the information may be comprised in the form of a hologram. From a hologram, information may be derived which represents an image taken with focus at a desired plane, often a horizontal plane so that the plane has a height/depth. This information will resemble an image taken with the desired focus depth/length where not only elements at or in the particular plane or depth/length are visible but where others may be present too. The elements in or at the plane are, however, more in focus, and this may be used to determine which elements are present at that depth/length. The image represented may instead resemble or be a cross-section of the sample.

In different imaging information, each of a plurality of elements are identified and their positions determined. Thus, the positions of these elements are tracked or determined in different imaging information and thus over time. Thus, from any movement thereof, the type or other parameters of each element may be determined. Naturally, the plurality of elements may be more than one element, such as all elements discernible in the imaging information, but often, the plurality of elements count 5-1000 elements, such as 10-500 elements, such as 15-100 elements.

Thus, from the information representing the image, it may be determined which elements are present in or at the depth/length in question.

In one embodiment, the imaging information is generated using variable optics or multiple sets of stationary optics so that different focus lengths/depths may be obtained using such optics.

In some embodiments, a hologram may be recorded of the sample. From a single hologram, an image or representation may be generated which has any focus length/depth. Any number of such images or representations may be generated for any number of focus lengths/depths in the sample. Thus, a sequence of holograms may be recorded, each being separate imaging information, whereafter the individual information representing each focus length/depth may be generated from the hologram.

A controller is provided. This controller may be hardwired or software controlled and may e.g. be a processor, DSP, ASIC, FPGA or the like. The controller may be formed by multiple elements communicating with each other.

The controller is configured to receive the sequence of imaging information. The controller thus may be in communication with the imaging element. This communication may be wired or wireless and may take place via any protocol or bus or even the WWW. The controller may be provided as a cloud service if desired.

The controller is configured to identify the same element in different imaging information, which is taken at different points in time. This determination may be based on a number of parameters of the sample and the imaging information. In a preferred embodiment, the element is assumed to move along a vertical path, so that the element is assumed to always be at a particular position in a horizontal plane. The element may further be assumed to be moving downwardly, so that the position of the element is additionally assumed to be at greater depths at later points in time. Alternatively, or additionally, another parameter of the element, such as a shape, an outline, an edge, a colour, reflection, emission, fluorescence, or internal contents may be used or identifying the same element in different imaging information. Cells may have a cell nucleus or other elements with a particular shape, position or number, which may be used for distinguishing between cells.

The vertical movement may be added to a horizontal movement if, for example, the sample is allowed to move, or is found to be moving, horizontally. Then, this horizontal movement may be compensated for if desired.

The controller is further configured to determine, for each imaging information, a position of the element in the sample container. As mentioned, the positions for the same element may, over time and thus between imaging information, be vertically displaced, horizontally displaced, or may move in the sample in another manner.

The controller is configured to determine, from the positions, the information relating to the element. This information may be a density or relative density compared to a density of a liquid of the sample. The controller may be configured to determine this information also based on a time difference between the imaging information. From a variation in position, such as a depth, and a period of time between the detection at the positions, a speed of the movement may be determined. This speed will be indicative of a difference in density between the liquid of the sample and that of the element. The speed may additionally or alternatively be indicative of which type the element is, such as what type of leukocyte the element is.

In another situation, the controller may additionally or alternatively determine a size of the elements. An element may sink (or float upwardly) with a speed determined by or indicating a size, such as a cross-sectional area in a vertical plane, thereof.

In a preferred embodiment, the imaging information is a hologram. Then, the imaging element is configured to generate a hologram or a sequence of holograms. Such imaging elements usually have a radiation or light emitter and a detector, often in the form of a 2D detector array, such as a CMOS sensor, a CCD array or the like. Different setups may be employed, such as on-axis (in-line) and off-axis holography setups, where the latter uses a tilted reference beam in order to separate the twin images from the real object in Fourier space. Also, or alternatively, multiple cameras may be employed for capturing images or data at different wavelengths, whereby more information may be determined from the sample. In one situation, radiation is launched through a pinhole and through the sample before it impinges on the detector.

When the imaging information is a hologram, methods exist of deriving, from the hologram, information, often in the form of 2D images or representations, of the sample, where these representations indicate not only the elements present at the particular length/depth but also other elements. From this information it may be determined which elements are present at the particular length/depth. Such methods may be Direct methods, such as angular spectrum backpropagation or transport-of-intensity, iterative methods such as gerchberg-saxton or sparse regularization reconstruction, and/or machine learning techniques, such as UNet, GAN, and Deep-Image-Prior methods, with varying levels of reconstruction accuracy.

In an alternative embodiment, the imaging information is generated by a more standard imager, such as a camera, having adaptable optics or multiple sets of fixed optics so that images may be provided having the different focus depths/lengths.

In one embodiment, when the imaging information is a hologram, the controller is configured to:
after the receiving step, derive, from each hologram, image representations of the sample, where each image representation relates to a separate focus length/depth of the at least two different focus lengths/depths,
identify, in the identifying step, each of the plurality of elements in at least two image representations relating to two different holograms and two different focus depths/lengths.

In general, as described, the same element is determined at different points in time and at different lengths/depths. From this, the information may be derived.

In one embodiment, the controller is configured to determine, as the information relating to at least one of the plurality of elements and from the positions of the one element, a density, absolute or relative to a liquid of the sample, of the pertaining element. From this density, a type of element may be determined.

In that embodiment, the controller may be configured to determine the density for the pertaining element based on a difference in focus length/height of the positions. This difference will indicate a vertical movement which may be caused by gravity and a difference in density between the element and a liquid of the sample.

In one embodiment, the element is a cell, such as a red blood cell, a leukocyte, a circulating tumor cell, or a bacterium. In that or other embodiments, an element may be crystallized material, a parasite or a bacterium. The element may alternatively be a parasite or platelet. Cells often are sufficiently heavy and/or have a size allowing them to move predictably, uniformly or generally in a downward direction, whereas platelets may be so small that they tend to remain suspended. Bacteria and especially parasites may be able to move themselves, so that their positions in the sample may not merely be vertical. A parasite may be determined when it moves sufficiently far horizontally or even upwardly. Horizontal movement may be determined the easiest if the sample is at rest in the sample container.

It is noted that it is possible to also determine Brownian motion from the imaging information, such as from a horizontal movement of e.g. platelets or any impurities being lighter than cells and thus not tending to sediment in the sample. This motion may be used for deriving e.g. a temperature of the sample. Also, any movement of such elements may, if e.g. detected in concert for many or all such elements, be used for indicating that the sample is moving. This may be used for compensating any movement determined of the other elements, or for discarding the determination.

Then, in one embodiment, the positions, over time, for one of the plurality of elements indicate a stochastic movement, and wherein the information relating to the one element indicates that the element is a platelet.

In that or another embodiment, the positions, over at least a predetermined minimum period of time, for one of the plurality of elements indicate an upwardly directed or sideward directed movement, and wherein the information relating to the one element indicates that the element is a parasite or a bacterium. Naturally, the predetermined minimum period of time would be long enough to rule out stochastic movements, such as caused by Brownian motions. This period may be 1s or longer, such as 2s or longer.

In such embodiments or in a separate embodiment, the positions, over time, for one of the plurality of elements indicate a generally downward movement with a descent rate within a first speed interval, and wherein the information relating to the one element indicates that the element is a cell.

Also, additionally or alternatively, the positions, over time, for one of the plurality of elements indicate a generally downward movement with a descent rate within a second speed interval, and wherein the information relating to the one element indicates that the element is a bacterium. The descent rates for cells and bacteria may be determined based on tests.

It may be desired to base the determination of the information on additional information. In addition to different density or size, also any internal structure thereof, a structure or shape of an edge thereof may be used.

In one embodiment, the controller is configured to determine edge information relating to an edge of the element in one or more of the image representations and to determine the information relating to the element based also on the edge information. The edge of a leukocyte is called the cell wall and differs between leukocyte types, and this information may be used in the determination.

A second aspect of the invention relates to a method according to claim 8.

All embodiments, considerations, situations and the like of the first aspect of the invention are equally relevant for the second aspect of the invention.

Thus, the sample, the body fluid, the elements, the sample container, the imaging element, the imaging information and the information representing the images may be as described above.

Also, the identification of the elements and the determination of the information may be as described above.

As is also described above, in a preferred embodiment, the generating step comprises generating a sequence of holograms. In this situation, the method may further comprise deriving, from each hologram, at least two image representations each relating to a separate focus length/depth of the at least two different focus lengths/depths, and wherein the identifying step comprises identifying each of the plurality of elements in at least two image representations relating to two different holograms and two different focus depths/lengths.

In one embodiment, the determining step comprises determining, as the information relating to at least one of the plurality of elements, a density of the pertaining element. This density and the determination are described above. Then, the determining step may comprise determining the density of the pertaining element based on a difference in focus length/depth of the positions.

In one embodiment, the element of the sample is a cell or bacteria. However, also platelets, parasites, crystallized material and other types of elements may be looked for and analyzed.

As mentioned above, Brownian motion may be determined and used for validating the measurement and/or for correcting a determined movement.

As indicated above, in one embodiment the positions, over time, for one of the plurality of elements indicate a stochastic movement, and wherein the information relating to the one element indicates that the element is a platelet.

In that or another embodiment, the positions, over at least a predetermined minimum period of time, for one of the plurality of elements indicate an upwardly directed movement, and wherein the information relating to the one element indicates that the element is a parasite or a bacterium. The period of time is described further above.

In any of those embodiments or in a separate embodiment, the positions, over time, for one of the plurality of elements indicate a generally downward movement with a descent rate within a first speed interval, and wherein the information relating to the one element indicates that the element is a cell.

Additionally or alternatively, the positions, over time, for one of the plurality of elements indicate a generally downward movement with a descent rate within a second speed interval, and wherein the information relating to the one element indicates that the element is a bacterium.

In one embodiment, the determining step comprises also determining edge information relating to an edge of the element in one or more of the image representations and determining the information relating to the element based also on the edge information.

Another aspect of the invention is based on the same relative movement and density but aims at determining a parameter of a fluid. This aspect relates to an apparatus for determining information relating to a body fluid, such as a body fluid, such as blood, serum, saliva, urine or the like, the apparatus comprising:
a sample container configured to receive a sample comprising the fluid and one or more particles with one or more predetermined parameters,
an imaging element configured to generate a sequence, over time, of imaging information, each imaging information comprising information representing an image of the sample in the sample container and at at least two different focus lengths/depths,
a controller configured to:
   receive the sequence of imaging information,
   identify the same element in different imaging information and determining, for each imaging information, a position of the element in the sample container and
   from the positions, determining the information relating to the fluid.

Also in this context, the movement of the particles is determined and used for generating the information. This time, the unknown constituent is the liquid.

Clearly, the positions of a plurality of elements may be determined in the different imaging information as is described above.

The liquid, the measurement set-up, the sample container, the controller and all other parameters, embodiments, situations and the like may be as described above.

The sample may be a filtered or otherwise sample stemming from a body fluid if desired. Also, other fluids may be analyzed in this manner. It is preferred that the particles are visible in the fluid and thus that the fluid is not too turbid, such as when translucent at least at one or more wavelengths used by the measurement set-up. The liquid may comprise other elements if desired.

The particles have one or more predetermined or predefined parameters, such as density and/or size. As described above, the relative density and optionally also the size of the particles will assist in determining the vertical speed of the particles. Thus, knowing the parameters of the elements or particles, information may be derived from the fluid.

A final aspect of the invention relates to a method of determining information relating to a fluid, the method comprising:
providing a sample in a sample container, the sample comprising the fluid as well as elements with predetermined parameters,
generating a sequence, over time, of imaging information, each imaging information comprising information representing an image of the sample in the sample container and at at least two different focus lengths/depths,
identifying the same element in different imaging information and determining, for each imaging information, a position of the element in the sample container and
from the position, determining the information relating to the fluid.

This then also relates to the determination of the information relating to the fluid. The same considerations as described above are relevant in relation to this aspect of the invention.

In the following, preferred embodiments are described with reference to the drawing in which:

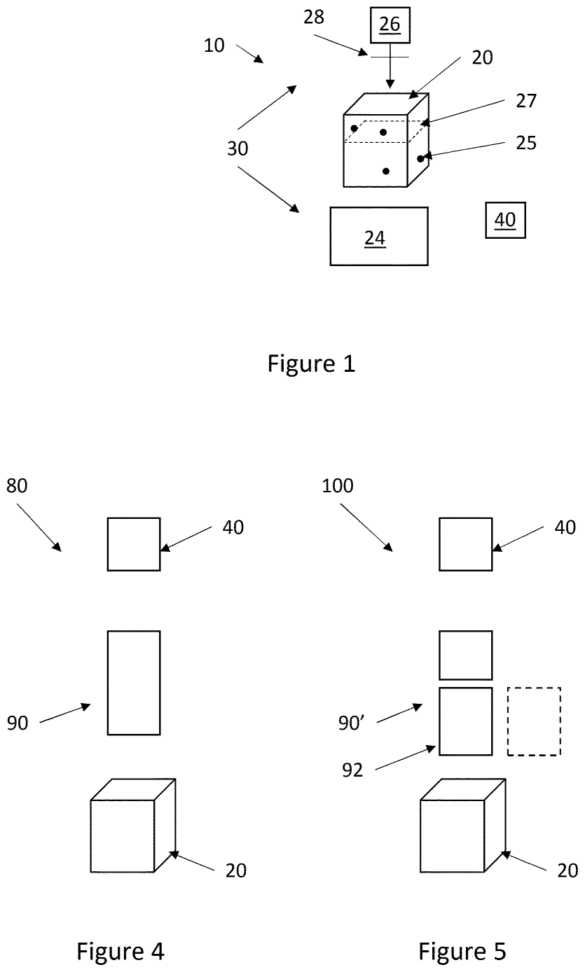

FIG. 1 illustrates a first preferred embodiment of an apparatus employing a holographic imager,

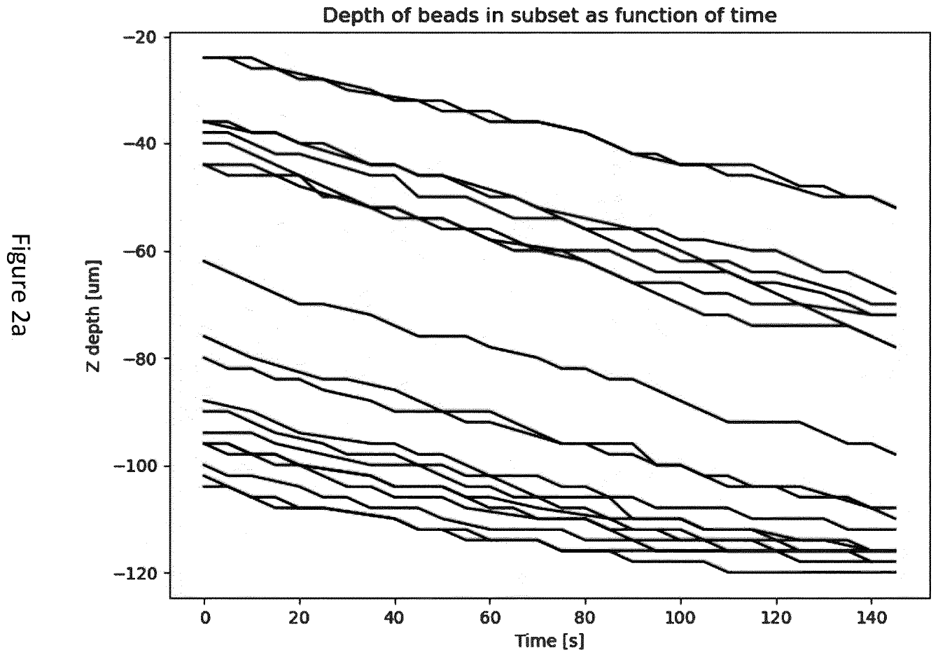

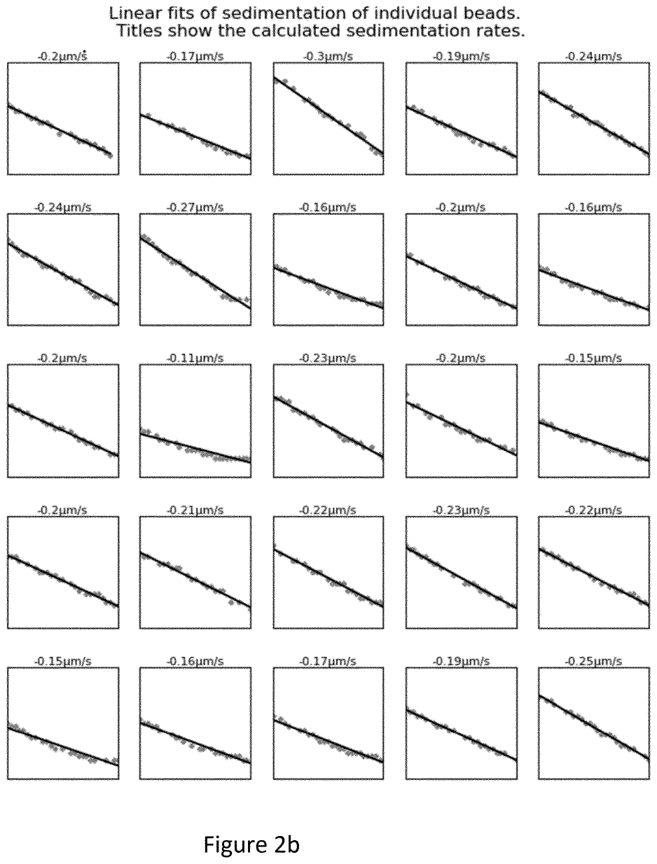

FIGS. 2a and 2b illustrates the sedimentation of cell-like beads in a sample,

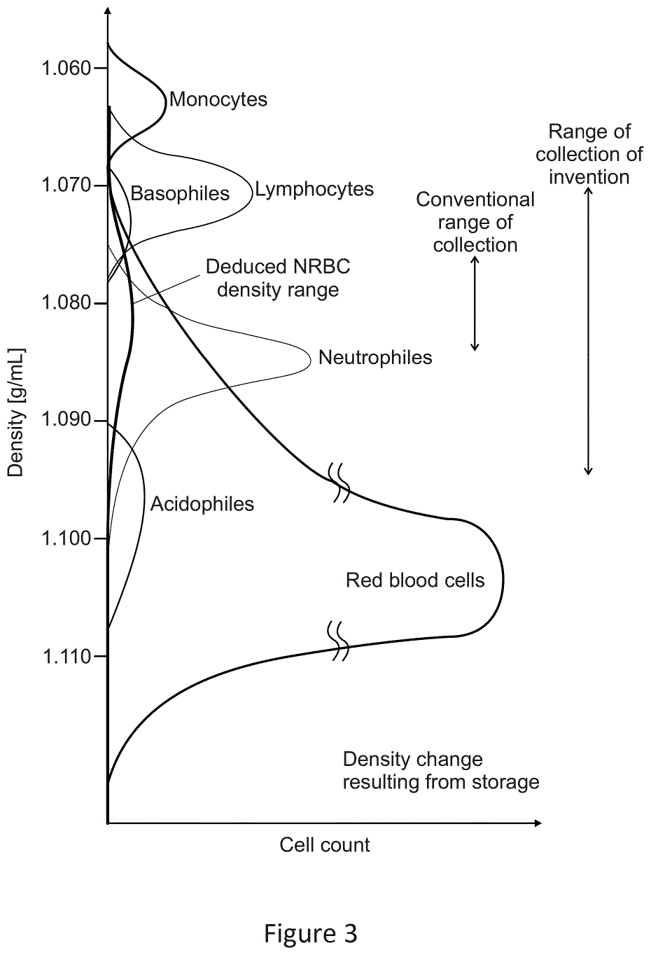

FIG. 3 illustrates the densities of typical blood cells,

FIG. 4 illustrates an alternative embodiment of an apparatus employing adaptable optics, and

FIG. 5 illustrates an alternative embodiment of an apparatus employing replaceable optics.

In FIG. 1, a preferred embodiment of an apparatus 10 is illustrated in which a sample holder 20 holds a sample which stems from a body fluid and which comprises elements of the body fluid, such as cells, bacteria, platelets, parasites or the like. The sample may be a treated body fluid, such as a sample in which constituents or components of the body fluid have been removed or altered, such as blood with lysed red blood cells, milk with dissolved fat or the like.

An image information provider 30 is provided in the form of a hologram imager configured to provide a hologram of the sample or a portion thereof. In this embodiment, the image provider comprises a light source 24, such as a LED, a pinhole 28 through which the light is fed to the sample holder 20. A detector or imager 24 such as a detector array, such as a CMOS array, is provided for receiving the light having penetrated the pin hole and the sample with the elements. An alternative to the LED and pinhole could be a laser or different configurations of light sources such as LEDs in concentric circles. Also, t may be advantageous to perform wavefront modulation on the source via e.g. SLMs or DOEs.

A controller 40 is provided for receiving the output of the imager 24 to derive a plurality images or information representing images of the sample at different focusing planes or depths.

The generation of such images or information may be seen in “Nonmechanical parfocal and autofocus features based on wave propagation distribution in lensfree holographic microscopy” by Dharmawan, Mariana, Scholz, Hörmann, Schulze, Triyana, Garcés-Schröder, Rustenbeck, Hiller, Wasisto and Waag, Scientific Reports, (2021) 11:3213. It is noted that when basing the determination of the images or information on a hologram, all such images or information is derived at the same point in time

The image information provider outputs a sequence, over time, of holograms and the controller then generates a sequence of sets of images or information from the sequence of holograms.

When the holograms are provided over time for the same sample, preferably while the sample is generally at rest, a number of different types of information may be derived from the sample.

When the different focus depths or lengths are displaced in a generally vertical direction, the density of elements of the sample may be determined from the determination of an element, such as a cell, at increasing or decreasing depths at increasing points in time. When the density of the liquid portion of the sample is known, a velocity of the sedimentation or floatation of the element may be used for determining the density of the element.

That an element, such as a cell, is present at a depth of a particular image or information may be determined from a sharpness of edges or constituents of the cell, such as a cell nucleus.

In Applicant's co-pending application EP22182762.9, filed on 4 Jul. 2022, a technology is illustrated by which it may be determined not only if a cell or other element is in the focus plane of an image but also whether the element is closer to or farther from the imager. Thus, this technique may alternatively or additionally be used for determining a depth at which an element of the image is seen at the point in time of recording of the pertaining hologram.

The position of an element 25, such as a cell, in the sample may be determined as a coordinate in a horizontal plane and a depth. The cell may then be identified in a later hologram and at another, typically larger, depth, by at least substantially the same coordinate in the horizontal plane but at the other depth.

In FIG. 1, one particle 25 is above the plane 27, defining a depth, one is in the plane and two are below the plane.

FIGS. 2a and 2b illustrate a measurement of a fluid in which beads of a size of 10 μm in diameter and a density of 1.055 g/ml are immerged in de-ionized water (1.0 g/ml) As the beads have a slightly higher density than that of the liquid, they will precipitate and thus be present over time at larger and larger depths. In FIG. 2a, the depth over time of 25 beads is seen when detected during 140 seconds. The sinking of the individual beads is seen in FIG. 2b together with a linear fit to the downward speed of each bead.

FIG. 3 illustrates the density of different types of blood cells. From FIG. 3 it is seen that different cell types will precipitate at different speeds due to their different densities. These different speeds may be used for characterizing or identifying the cell types.

In addition, other information may be used for characterizing the elements, such as visual elements such as the shape, outline, colour or the like of portions of the elements, such as a cell membrane, a cell nucleus or other constituents thereof. Different leukocytes have different sizes and shapes of the membrane and nucleus and different “fluffiness” thereof. These parameters may be determined from the images/information and be used in the characterization of the individual element.

Clearly, elements having a density lower than that of the liquid would move upwards in the sample. The upward speed may be used in the same manner for characterizing the element and/or deriving the information relating thereto.

Also, horizontal movement may be determined where an element is identified over time at at least substantially the same depth.

Horizontal movement may be caused by e.g. Brownian motions, whereby elements with approximately the same density as the liquid, and/or elements of a so small size that they will precipitate or float only very slowly, will move more or less stochastically and thus also vertically. Thus, from the movement of such elements, the size of the Brownian motion may be determined, and this may be used for compensating the density or speed determination of the heavier/lighter/larger elements.

Such small elements of the sample may be platelets, larger assemblies of platelets, bacteria and impurities, such as unintended portions of the sample, such as colour crystals stemming from a preparation of the sample.

It may also be desired to determine non-Brownian motion of the particles, such as convection from air bubbles in the vicinity. This may also be used as an indication that the sample is not at rest and that the measurement is flawed. In addition, if a number of, such as all, determined elements move or have a movement component in concert, this concerted movement may be used as an indication that the sample in the sample container is not at rest. Then, the movement of the individual elements may be compensated for this concerted movement, or the analysis may be halted until a later point in time where the sample is assumed to be at rest.

Also, parasites may be present in the body fluid. Some parasites and some bacteria are able to themselves move in the body fluid. A parasite/bacteria may then be characterized or identified when determined at varying depths, such as when moving both up and down, and when moving in the horizontal plane—such as in excess of any motion potentially caused by Brownian motion.

In FIG. 4, an alternative embodiment of an apparatus 80 is seen in which the sample in the sample container is imaged using an imager 90 which has adaptable optics, such as a variable lens, for providing a sequence, for the same sample, of images with different focus length or depth. By swiftly altering the optics, a sequence of images may be provided with different focus depths while it may be assumed that the position of the elements of the sample have not moved substantially. It is noted that the determination of the above information relating to depth/position and time of the elements may be performed where different depths of the same sample are imaged at different points in time. These points in time may be logged and used in the determination of the information relating to the elements of the sample.

In FIG. 5, another alternative 100 is seen in which the imager 90′ has replaceable lenses 92 where each lens is fixed to a particular focus depth. Thus, the lenses 92 are sequentially brought into the optical path between the sample container and the imager 90′ so that, again, a sequence of images may be provided for the same sample and at different focus depths.

As indicated above, the figures and the description relate to the determination of parameters of particles in a liquid, the relevant parameter(s) of which is/are preferably known. The same set-up may be used for determining parameter(s) of a liquid when parameters of the particles are known. Thus, when the particles are known, the up/downward movement thereof, determined as described above, may be used for determining parameters of the liquid.

In this context, as also described above, the liquid may be a body fluid, such as a filtered or otherwise treated body fluid.

1. An apparatus for determining information relating to elements of a body fluid, the apparatus comprising:
(a) a sample container configured to receive a sample comprising the elements of the body fluid;
(b) an imaging element configured to generate a sequence, over time, of imaging information, each imaging information of the sequence comprising information representing an image of the sample in the sample container and at at least two different focus lengths; and
(c) a controller configured to:
(i) receive the sequence of imaging information,
(ii) identify each of a plurality of elements in different imaging information and determine, for each imaging information, a position of each of the plurality of elements in the sample container, and
(iii) from the positions, determine the information relating to each of the plurality of elements.

2. An apparatus according to claim 1, wherein the imaging information is a hologram.

3. An apparatus according to claim 2, wherein the controller is further configured to:
(iv) after receiving the sequence of imaging information, derive, from each hologram, image representations of the sample, where each image representation relates to a separate focus length of the at least two different focus length, and
(v) identify, in the identifying step, each of the plurality of elements in at least two image representations relating to two different holograms and two different focus lengths.

4. An apparatus according to claim 1, wherein the controller is further configured to determine, as the information relating to at least one of the plurality of elements and from the positions of the one element, a density of the pertaining element.

5. An apparatus according to claim 4, wherein the controller is further configured to determine the density for the pertaining element based on a difference in focus length of the positions.

6. An apparatus according to claim 1 wherein each of the plurality of elements is a cell, a platelet, crystallized material, a parasite, or a bacterium.

7. An apparatus according to claim 1, wherein the controller is further configured to determine edge information relating to an edge of at least one of the plurality of elements in one or more of the image representations and to determine the information relating to the one element based also on the edge information.

8. A method of determining information relating to elements of a body fluid, the method comprising:
providing a sample in a sample container, the sample comprising the elements of the body fluid;
generating a sequence, over time, of imaging information, each imaging information of the sequence comprising information representing an image of the sample in the sample container and at at least two different focus lengths;
identifying each of a plurality of elements in different imaging information and determining, for each imaging information, a position of each of the plurality of elements in the sample container; and
from the positions, determining the information relating to each of the plurality of elements.

9. A method according to claim 8, wherein the generating step comprises generating a sequence of holograms.

10. A method according to claim 9, further comprising deriving, from each hologram, at least two image representations each relating to a separate focus length of the at least two different focus lengths, and wherein the identifying step comprises identifying each of the plurality of elements in at least two image representations relating to two different holograms and two different focus lengths.

11. A method according to claim 8, wherein the determining step comprises determining, as the information relating to at least one of the plurality of elements, a density of the pertaining element.

12. A method according to claim 11, wherein the determining step comprises determining the density of the pertaining element based on a difference in focus length of the positions.

13. A method according to claim 9, wherein each of the plurality of elements is a cell, a platelet, crystallized material, a parasite, or a bacterium.

14. A method according to claim 8, wherein the determining step comprises also determining edge information relating to an edge of the element in one or more of the image representations and determining the information relating to the element based also on the edge information.
